(19) United States
(12) Patent Application Publication
(10) Pub. No.: US 2026/0084343 A1
(43) Pub. Date: Mar. 26, 2026

(54) Spill Prevention System for Mixing Trucks

(71) Applicant: Joshua Jameson, Acworth, GA (US)

(72) Inventor: Joshua Jameson, Acworth, GA (US)

(73) Assignee: Black Rock Tech, Acworth, GA (US)

(21) Appl. No.: 18/893,482

(22) Filed: Sep. 23, 2024

(51) Int. Cl. B28C 5/42; H04Q 9/00

(52) U.S. Cl. CPC B28C 5/422; H04Q 9/00; H04Q 2209/43

(57) ABSTRACT

A monitoring system apparatus for mixer trucks is disclosed that detects mixer drum rotation to increase the situational awareness of a human operator by notifying them when the mixer drum begins rotating in discharge rotation to prevent spill incidents.

### CROSS-REFERENCE TO RELATED APPLICATION

This application is a non-provisional of, and claims the benefit of priority to, U.S. Provisional Ser. No. 63/591,371, titled, “Discharge Rotation Alert System for Concrete Mixing Trucks”, filed on Oct. 18, 2023, which is hereby incorporated by reference in its entirety.

### FIELD OF THE INVENTION

The present invention generally relates to apparatus and methods of improving situational awareness of drivers and operators of mobile mixer trucks, and, specifically, to apparatus and methods of monitoring mixer drum rotation on concrete mixer trucks.

### BACKGROUND OF THE INVENTION

Mobile mixer trucks are used to mix displaceable materials while on-route to the delivery site. Concrete is commonly transported this way where the separate ingredients are loaded into the truck at a central location and mixed on the truck while in transit. The materials are stored and mixed within a large rotatable container with spiral blades, referred to as the drum. The drum can rotate in two directions such that when the drum rotates in one direction, the contained materials stay within the drum and mix; when it rotates in the opposite direction, the contained material is discharged from the drum. The rotational direction that expels the contained material is commonly referred to as the discharge direction.

Normally while in transit, the drum rotates in the direction that mixes and keeps the contained material inside the drum. However, occasionally, the drum can unintentionally go into discharge rotation and spill the contained material onto the ground. These accidental spills can contaminate roadways, sidewalks and elsewhere creating hazardous road conditions for other vehicles, damage property, harm the environment and incur expensive clean-up costs.

Unintentional discharge rotation can be initiated by human error or by mechanical malfunctions of the controls or drive mechanics controlling the rotation of the drum. In mixer trucks, because the drum is visible to the driver through rear-view mirrors, it is often assumed that the driver will notice if the drum is unintentionally rotating in discharge. However, since it can take only a few seconds for contained material to begin expelling from the drum and less than a couple minutes to fully discharge the entire contents of the drum, often the driver does not notice in-time to prevent a spill from occurring. The primary purpose of the disclosed invention is to quickly alert the truck driver with a noticeable signal when the drum is in discharge rotation, so they can act to prevent spills.

Various mixer truck drum rotation monitoring apparatus and methods are described in prior art and available commercially for the purpose of managing the properties of the contained material inside the drum while in transit.

U.S. Pat. No. 9,952,246 describes how combined data from a gyroscope and an accelerometer mounted to the rotating drum can be used to precisely measure drum rotation speed in the same direction over long periods of time (on the order of minutes to hours). Since gyroscope readings tend to drift over time when the rotational direction is the same, the data from the accelerometer can be used to calibrate the gyroscope reading to reduce error. The present invention is concerned with detecting changes in rotational direction in a short period of time (on the order of seconds to minutes), therefore the use of a gyroscope not continuously calibrated for drift would be sufficient.

U.S. Pat. No. 11,897,167 discloses a system where signals from an accelerometer placed within a mixing drum are compared to baseline signals from an accelerometer outside of the mixing drum to determine properties of the contents. Similarly, U.S. Pat. No. 9,833,928 discloses the use of rotational sensing in combination with a force-sensing blade inside the drum to monitor the contents of the mixing drum. In contrast to this prior art, the present invention mounts externally to the mixing drum and is agnostic to the contents inside the drum.

Low-power, wirelessly-connected sensors that mount externally to concrete mixing drums have been previously disclosed. For example, U.S. U.S. Pat. No. 9,518,870 discloses a low-power sensor devices that externally mounts to the mixing drum and wirelessly transmit temperature data for purposes of monitoring “slump” and other physical properties of the concrete in the mixing drum. While the present invention could use similar power management techniques, mounts externally to the mixing drum and wirelessly transmits data to a processing device located elsewhere on the truck, the present invention does not monitor temperature and is agnostic to the properties of the contents inside of the mixing drum.

Some of the prior art describes active control of the mixer drum rotation. For example, U.S. Pat. No. 11,858,172 discloses a drum rotation monitoring system that actively adjusts the drum rotation speed to ensure the concrete mixed in transit has the intended properties when it is delivered to the jobsite. Additionally, U.S. Pat. No. 10,744,676 discloses a system that monitors various aspects of the mixer truck, including the truck's incline angle to actively adjust the drum's rotational speed to reduce the likelihood of spills. In contrast, the present invention passively monitors drum rotation to alert the operator when discharge rotation occurs.

While these known systems provide process control advantages that can improve the consistency and quality of contained materials till delivery, these systems do not make the operator aware when the drum is unintentionally in discharge rotation. Additionally, existing apparatuses require complex installation procedures that require skilled technicians to integrate into a mixer truck. Therefore, a need exists for a device that can alert the operator of unintentional discharge rotation of the mixing drum that can be retroactively installed to existing mixer trucks with minimal time and effort.

### SUMMARY OF THE INVENTION

Generally, the present invention provides a system for monitoring rotation of a mixing drum and notifying its human operator when the drum is in discharge rotation. In a preferred embodiment, the system disclosed includes a gyroscopic sensor externally mounted to the mixing drum that wirelessly transmits status information to a processor, located less than about ten meters away from said gyroscopic sensor, which can interpret the transmitted status information and produce a combination of visual and audible signals that can communicate the status information to a human operator nearby.

As used in this specification and the appended claims, the terms “mixer drum” or “drum” both refer to a rotatable container with spiral blades configured to mix and keep contained material while rotating in one direction and expel the contained material when rotating in the opposite direction. The term “contained material” refers to a displaceable material (such as wet concrete, powders, or liquids) held within the mixer drum. The term “discharge rotation” is used to refer to the movement of the drum in the rotational direction that causes contained material to be expelled from the drum.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of specification and serve to further illustrate various embodiments and to explain various principles and advantages all in accordance with the present invention, in which:

FIG. 1 is a simplified block diagram illustrating the flow of information between elements of a system according to an embodiment of the invention;

FIG. 2 is a side view of a rear discharge mixer truck illustrating the preferred installation locations of an embodiment of the invention;

FIG. 3 is a process flow chart of the system of a preferred embodiment;

FIG. 4 is an exploded view of the sensor unit according to a preferred embodiment of the invention;

FIG. 5 is an exploded view of the alarm unit according to a preferred embodiment of the invention;

FIG. 6 is a flow chart of the method steps for using an apparatus according to an embodiment of the invention.

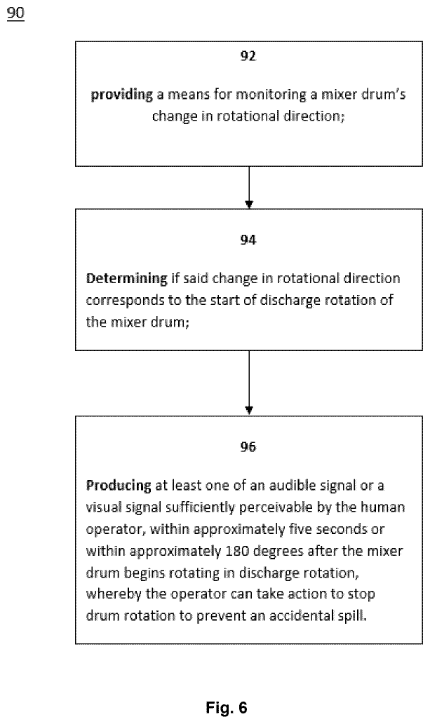

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

The present invention will now be described with reference to the accompanying figures.

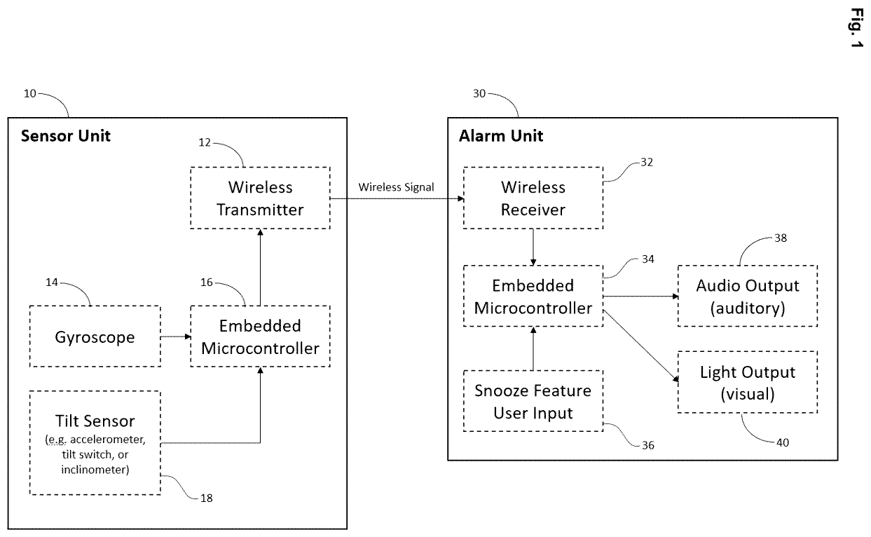

Referring to FIG. 1, a block diagram illustrates that a preferred embodiment of the invention consists of two key elements: a sensor unit 10 and an alarm unit 30. The sensor unit 10, actively monitors the rotation of the mixer drum 62 with a gyroscope 14. A microcontroller 16 interprets the data from the gyroscope and determines if the mixer drum 62 is rotating in discharge rotation. A wireless transmitter 12 is used to send data from the sensor unit's microcontroller 16 corresponding to the drum's rotational movement, to the alarm unit's microcontroller 34 via the alarm unit's wireless receiver 32. The alarm unit 30 utilizes at least one of an auditory output 38 or a visual output 40 to communicate the system status to the operator of the mixer truck 60.

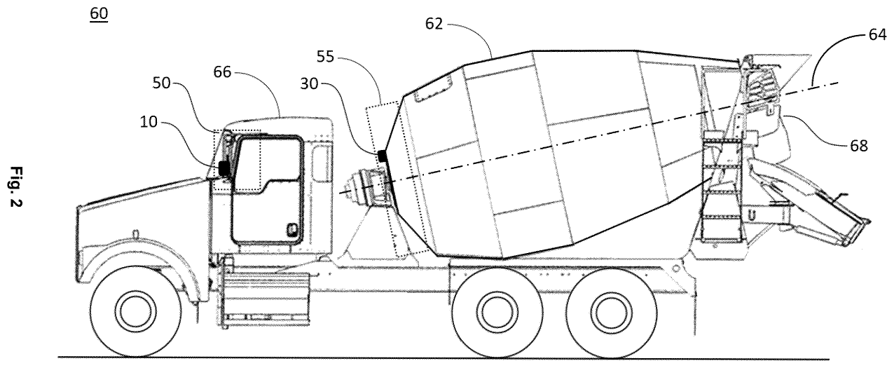

Referring to FIG. 2, the preferred installed locations of the sensor unit 10 and alarm unit 30 are shown in relation to a rear-discharge mixer truck 60. A rear-discharge mixer truck 60, has a mixer drum 62, with internally mounted, spiral blades that when rotating in one direction about the drum's rotational axis 64, the material contained within the mixer drum 62 is mixed and kept within the drum 62; when rotating in the opposite direction about the rotational axis 64, the spiral blades move the contained material up to and out of the opening in the mixer drum 68 located at the rear of the vehicle.

In a preferred embodiment, the sensor unit 10 is physically mounted to the outside of the rotatable mixer drum 62 on a mixer truck 60. The preferred location 55 of the sensor unit on the outside of the mixer drum on the end of the drum closest to the cab 66, on a surface that approximately perpendicular to the drum's axis of rotation. The alarm unit's preferred location 50 is in the cab of the truck 66 in a position normally in view and within arm's reach of the operator while driving the truck 60. While the alarm unit 30 could also be entirely unmounted within the cab 66 or it could be positioned outside of the cab 66, such as on the outside of a window, side mirrors or the hood of the truck, these locations would make it difficult for the operator to hear the audible notifications and would place the alarm unit 30 outside of their reach.

The sensor unit 10 monitors the rotation of the mixer drum 62 about the drum's rotational axis 64 and makes a wireless broadcast about the drum's rotational status. The alarm unit 30 detects this wireless broadcast and alerts the driver with a combination of attention-grabbing, audio-visual signals, such as solid or flashing lights, and/or pulsing beeps or tones.

An operator will regularly put the drum 62 into discharge rotation to intentionally expel the contained material at a delivery site or other location to unload the material from the truck 60 or to clean the drum 62. The sensor unit 10 will notify the alarm unit 30 both in these intentional situations as well as unintentional ones. The alarm unit 30 could utilize additional situational information gathered from other sensors to determine what type of signal, if any, to communicate to the operator the rotational status of the drum 62. Since the alarm unit 30 is intended to be able grab the operator's attention to notify about discharge rotation, it can be annoying and perhaps even distracting to the operator if they are frequently intentionally discharging the drum 62. To help relieve this potential issue, a snooze feature input 36 on the alarm unit 30 can be employed to temporarily disable or modify either one or both the audio and/or visual alert signals coming from the alarm unit 30. To prevent the driver from accidentally disabling the alarm unit 30 indefinitely, a snooze state should only last for a predetermined period of time (somewhere between one minute and sixty minutes).

In a preferred embodiment, this snooze feature input 36 is easily accessible to the driver by a prominent button 37 on the alarm unit 30 that is easy to find and press. The driver should be able to determine if the alarm unit 30 is in a snoozed state by an identifiable visual signal (such as an LED of a particular color, shape and/or position), and/or an audio signal (such as a constant tone or quiet and pleasant sound). The driver should also be able to bring the alarm unit 30 out of the snooze state as desired by such method as pressing the same snooze feature input 36 that enabled the snooze function, separate reset button or similar action.

In a preferred embodiment, the light output 40 is a high-intensity RGB LED which illuminates a translucent window 39 on the alarm unit's housing. This translucent window 39 helps to disperse light from the light output 40 through the alarm unit's housing, making said light clearly visible to an operator from a wide range of viewing angles. The light output 40 flashes when discharge rotation is detected to capture the attention of the operator. When the alarm unit 30 is in a snoozed state, the audio output 38 is silenced.

### Means for Detecting Discharge

The primary purpose of the present invention is to alert an operator when the contained material could be discharging from the mixer drum 62. Therefore, a means for monitoring potential discharge activity is required. This could be done with several different approaches including detecting control signals or mechanical components driving the rotation of the drum 62, monitoring the movement of the contained material near the opening of the drum 68, or directly monitoring the physical rotation of the drum 62.

The mixer drum 62 on a mixer truck 60 could be controlled by a user interface control panel located in one or more locations on the mixer truck 60. Often there are at least two user control panels to control the drum's rotation; one in the cab of the truck 66, and one near the opening of the drum 68. Additionally, some mixer trucks have autonomous systems that also control the rotation of the drum 62 for safety or control over the contained material's physical properties. Between these signal controls are various mechanical system components which physically drive the drum's rotation. These mechanical components often include hydraulic pumps, valves and motors. The present invention avoids this approach as it would be difficult to install such as system consistently into the wide variety of mixer trucks and because in the event of a failure of a downstream component, such as hydraulic valve or mechanical transmission, the sensor monitoring upstream components would not be capable of accurately knowing if the status of the rotational movement of the drum 62.

Another approach is to place a sensor or multiple sensors capable of detecting the contained material, near the opening of the drum 68, to detect if the contained material is approaching the opening of the drum 68, or actively passing through the opening 68. This could be done with a camera coupled with machine vision placed near the opening of the drum 68 with a clear view of the path that the contained material must move through to escape the drum 62. Alternatively, a proximity sensor such as an infrared distance sensor or ultrasonic distance sensor could be positioned near the opening of the drum 68 to monitor the presence of contained material as it approaches the opening of the drum 68. Alternative sensing of contained material movement could be done by a mechanical means such as a switch configured to activate by the displaced contained material approaching or passing through the opening 68. While these directly monitor the movement of the contained material out of the drum 62, they present various challenges for accurate and reliable sensing, system installation and maintenance.

The present invention takes the approach of directly monitoring the rotational movement of the mixer drum 62 to predict whether discharge of the contained material is likely to occur. For this approach, the sensor unit 10 must have a means for detecting the rotational direction of the mixer drum 62 and be able to communicate correlated data to the alarm unit 30. The senor unit 10 must be able to reliably detect the rotational direction of the rotating mixer drum 62 within a rotational speed range between approximately six degrees per second and least 100 hundred degrees per second. To be effective in providing a timely alert to the operator, the means for detecting the rotational direction must be able to determine the rotational direction within about five seconds or within approximately one hundred and eighty degrees of rotation of the drum 62 (whichever occurs first), after the drum 62 begins to rotate in that direction.

The sensor unit 10 could monitor the rotation of the drum 62 by being mounted to a stationary place on the mixer truck 60, near to the mixer drum 62, or directly mounted to the drum 62. If the sensor unit 10 were mounted to a stationary position relative to the mixer drum 62, it could monitor the rotation of the drum 62 in several different ways. One method is with a wheel that physically contacts the drum 62 so that the wheel rotates synchronously with the rotation of the drum 62. An encoding mechanism such as an optical counter, magnetic strips or mechanical contacts could be used to detect the rotation of this wheel to monitor the rotational direction of the drum 62. Alternatively, distinct, identifiable elements could be placed at regular intervals around the drum 62 such that a stationary sensor could detect the elements as they passed by the sensor with the drum 62 as it rotated. While both methods could work, they would present various difficulties for installation, long-term robustness and reliability of sensing drum rotation.

In a preferred embodiment, the sensor unit 10 would be physically mounted to the mixer drum 62, as this has the advantage of a very simple installation process as compared to a stationary sensor configuration. Several different types of rotational sensing means could be used where a sensor unit 10 mounted to the mixer drum 62 such that it rotates about the mixer drum's rotational axis 64 synchronously with the mixer drum 62. A sensor mounted directly to the rotating drum 62 would need to filter out potentially confounding movements produced by the mixer truck 60 in motion.

One means to filter out the vehicular movements from confounding the sensor's readings is to provide two sensors: one which is fixed in a stationary position on the mixer truck 60 and another mounted on the drum 62. Comparison between signals from these two sensors would allow determination of drum's rotation. A gyroscopic sensor inherently filters out movement in other directions and rotation about other axis, so positioning the gyroscopic sensor in a location closely aligned with the rotational axis of the drum 64 would filter out most of the noise from movement of the mixer truck 60. The axis of rotation of the drum 64 on a mixer truck 60 is approximately between ten degrees and twenty degrees from the horizontal when the mixer truck is on level ground. Because of this slight angle, a rotational sensor configured to measure rotation of the drum 62 could also pick up movement of the mixer truck 60 driving around turns.

One of the simplest means to detect drum rotation would be to place single-axis gyroscope, mounted in the preferred location of the sensor 55, which would produce signals closely correlated to the rotational movement of the mixer drum 62. This physical position on the mixer drum 62 combined with a simple averaging filter implemented on the sensor's data could be employed to accurately read the drum's rotational direction and filter out potentially confounding movements of the mixer truck 60.

Detecting single-axis rotation about the mixer drum's axis of rotation 64, can also be accomplished by using other sensing means such as a series of tilt sensors and/or tilt switches positioned at different angles relative to each other and with respect to gravity. A similar means would be to use a conductive ball able to roll around a circular channel with periodic contacts that are triggered as the ball passes by. Alternatively, a weight positioned at the end of an arm that is able to freely rotate with gravity pulling on the weight, and has a positional encoding means such as magnetic, optical, or electro-mechanical contacts to detect the rotation of this arm. Alternatively, signals from a single or multi-axis accelerometer positioned tangentially to the axis of rotation 64, could be analyzed to determine the rotational direction.

While various rotational sensors could be utilized, a preferred embodiment uses a MEMS-based inertial measurement unit (IMU) for its accuracy, resolution, robustness, minimal size, low-power requirements, and wide commercial availability. An IMU that contains at least one gyroscope and at least one accelerometer whose detection axis are perpendicular to one another is preferred. The gyroscope has the advantage of nearly instantaneously measuring both the rotational speed and rotational direction, while the accelerometer serves as a tilt sensor 18 which can be used to wake up the device from a deep sleep. Utilizing the combination of both a gyroscope 14 and a tilt sensor 18 allows the sensor unit 10 to remain in an ultra-low power consumption sleep mode until a predetermined motion event occurs. In a preferred embodiment, the senor unit's electrical components including gyroscope 14, tilt sensor 18, microcontroller 16, and wireless transmitter 12, could be configured to fit on a single printed circuit board assembly (PCBA) 13.

The combination of both a gyroscope and accelerometer provide additional benefits and affordances that allow for more sophisticated motion sensing capabilities than is needed for the present invention; especially if the IMU contains more degrees of freedom, such as a three-axis accelerometer and three-axis gyroscope. Since the present invention is concerned with quickly notifying an operator that the mixer drum 62 has started rotating, the primary function of the sensor unit 10 is simply to detect a change in rotation to the discharge rotational direction within a few seconds. An accelerometer configured to operate only as a tilt sensor 18 to wake-up the sensor unit's microcontroller 16 upon a tilting event (approximately every forty-five or ninety degrees perpendicular to the direction of gravity), would allow the microcontroller 16 to power up a gyroscope 14 and acquire the rotational direction mixer drum 62 within a few seconds after the drum 62 has started rotating.

### Functional Requirements and Considerations for a Commercial Product of the Present Invention

Ideally, the sensor unit 10 should be able to use very little power and therefore could be powered by a small internal power source, such as small batteries 15 that are periodically replaced. As a commercial product, there is an economic advantage to having to replace the batteries infrequently as the cost of maintenance increases when frequent battery changes are needed. Alternatively, the sensor unit 10 could be powered by a rechargeable source such as super-capacitors or rechargeable batteries. The power to recharge an internal power storage could be provided by solar panels, an external wireless charging transmitter, an electro-mechanical generator, or through an external electrical power source.

The sensor unit 10 could be mounted to a mixer drum 62 using various means, such as bolts or adhesives. In a preferred embodiment, the sensor unit 10 attaches to the drum 62 using permanent magnets 17. This is possible because a mixer drum 62 is typically made from steel which is ferromagnetic. This type of mechanical connection makes the sensor unit 10 very quick and easy to mount and dismount from the mixer drum 62 without any use of tools or modifications to the drum 62 or mixer truck 60. The magnetic connection must be sufficiently strong enough to ensure that the sensor unit 10 does not move in-relation to the drum 62 and remains attached even when a wide range of external forces are applied. These forces include, but are not limited to: centrifugal force from the drum's rotation, forces from the mixer truck's acceleration and deceleration while in transit, bumps on the road, high wind loading, and water pressure from driving rains or a stream of water from a cleaning hose.

Ideally the sensor unit 10 should be mounted to the outside of the drum 62 to make it quick and easy to access for mounting and dismounting, visual inspection, and maximizing wireless signal range. The magnetic connection must be strong enough to keep the sensor unit 10 securely mounted during normal operation and cleaning, but easy for a person to be able to quickly grab and pull-off from the drum 62. A preferred embodiment utilizes multiple small magnets 17 positioned around the perimeter of the housing to provide multiple magnetic connection points. On a rear-discharge mixer truck 60, the preferred mounting location for the sensor unit 55 is on any of the faces on the drum 62, closest to the truck's cab 66. This position ensures that the sensor unit 10 and alarm unit 30 are sufficiently close to facilitate reliable wireless communication between the units. Additionally, this preferred location 55 is easy to view and physically access by an operator to install, inspect and remove the sensor unit 10 as needed.

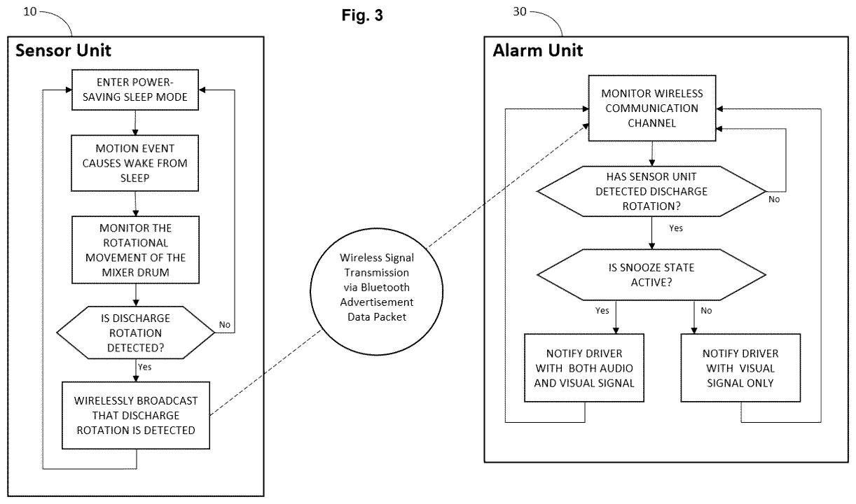

In a preferred embodiment of the invention, the sensor unit 10 uses small, readily available batteries 15, such as coin/button cell batteries, AAA or AA batteries. To operate on small batteries for months before requiring replacement, the sensor unit 10 must utilize ultra-low-power techniques and technologies. One method of power consumption optimization is by remaining in a deep-sleep mode until a relevant motion is detected. A deep-sleep mode is an electronic method of powering down unnecessary electrical components and slowing down and/or pausing the processor from executing instructions. As soon as a predetermined motion is detected, the device wakes up, monitors the movement behavior reported by a gyroscope 14, and within a few seconds determines if the movement correlates to the discharge rotation of the drum 62. If discharge rotation is detected, the sensor unit 10 then transmits a signal to the alarm unit 30 with data corresponding to the discharge rotation. To save power, the signal transmission only lasts while discharge rotation is detected. Once the rotation stops, the sensor unit 10 goes back into a deep-sleep mode. FIG. 3 illustrates this power-saving mode of operation method as a flow chart.

Wireless communication between the sensor unit 10 and alarm unit 30 is the preferred means of signal transmission because it has the advantage of being able to maintain a continuous connection of communication between the physically moving sensor unit 10 and the stationary alarm unit 30 without mechanical wear and tear. Additionally, it allows installation without the need of custom wire-routing between the two units in different mixer trucks and accommodates hot-swapping between different sensor units to facilitate interchangeability with different alarm units. Wireless communication could have the disadvantage of being susceptible to electromagnetic interference and noise, however, if the sensor unit 10 and the alarm unit 30 are installed on a mixer truck 60 in their respective preferred locations (50 and 55), the units would remain in close-proximity with very few obstacles to interfere with the signal transmission.

While there are numerous wireless communication techniques and methods using different frequencies and data transmission protocols, in a preferred embodiment the sensor unit 10 broadcasts a wireless signal via Bluetooth Low Energy (BLE) advertising packets. BLE is a well-supported, standard wireless protocol that is optimized for extremely low-power devices. Additionally, if BLE protocols are utilized, the devices actively listen to signals and noise from nearby devices and communicate in the gaps between other signals to avoid potential interference.

The sensor unit 10 could alternatively communicate to the alarm unit 30 with a wired electrical connection (such as a conductive wire), via a mechanical connection (such as a hydraulic cable, rotating flexible shaft, or pneumatic pressure cable), or via optical signal broadcast in a line-of-sight or carried through an optically conductive fiber-optic cable. These alternative means of communication are better suited for configurations of the system where the sensor unit 10 is mounted stationary relative to the alarm unit 30. In configurations where the sensor unit 10 is mounted to the mixer drum 62, these methods could be prohibitively complex to install and maintain.

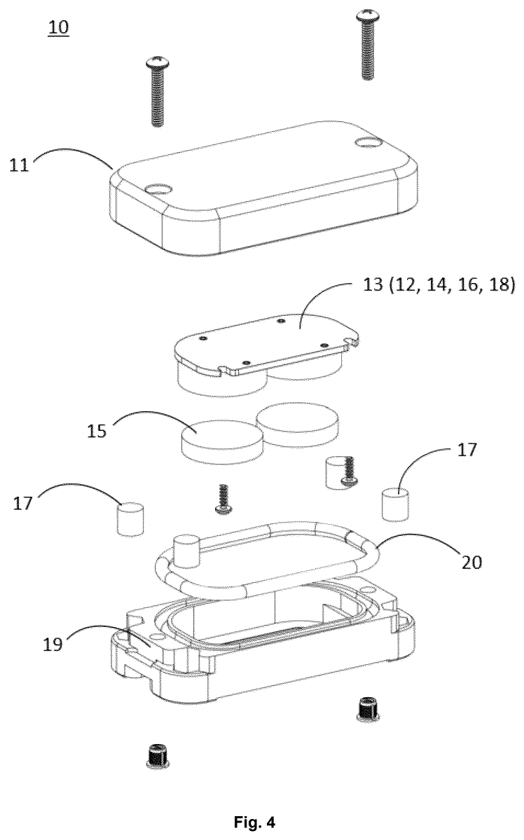

The sensor unit 10 must be robust enough to handle outdoor conditions including but not limited to: humidity, rain, snow, long-term UV sunlight exposure, and temperatures exceeding approximately fifty degrees Celsius and minus forty degrees Celsius. Additionally, it should be able to withstand the cleaning processes and chemicals used to regularly clean the mixer truck 60. FIG. 4 illustrates the physical components of an exemplary apparatus of the sensor unit 10. To help make the sensor unit 10 robust enough to withstand said environmental conditions, it would be made using engineering grade polymers for the housing top cover 11 and housing bottom cover 19, and would have a gasketing component 20 to prevent water ingress.

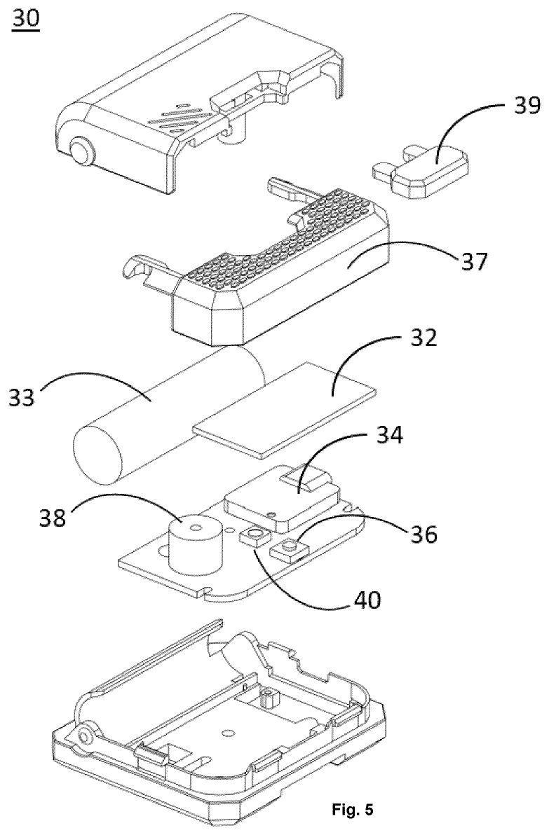

The alarm unit 30 is intended to remain within the cab of the truck 66 in the approximate region of the preferred location 50, and therefore does not need to be as water resistant or withstand the same outdoor conditions as the sensor unit 10. However, it should still be able to handle a similar temperature range as the sensor unit 10. FIG. 5 illustrates the physical components of an exemplary apparatus of the alarm unit 30.

The alarm unit 30 should be powered and actively listening for signals from the sensor unit 10 as much as possible to help ensure that it catches the sensor unit's broadcasted status data at any given time. This preferred active listening behavior as well as the need to sufficiently power the audio output 38 and visual output 40 requires a substantial amount of energy. Although the alarm unit 30 could be powered by a very large internal battery or externally from solar power, in a preferred embodiment, an external power source is provided by the mixer truck's electrical system. Ideally a USB port within the cab of the truck 66 would provide the power needed to maintain the continuous functionality of alarm unit 30. A small rechargeable battery 33 within the alarm unit 30 could be used to provide power when the device is temporarily disconnected from the external power-source. Alternative or additional power sources could include solar-panels and/or wireless charging from an external power source. The alarm unit 30 could be configured to directly mount into a lighter port or USB port and therefore not require a separate power cable. However, using a power cable allows for the alarm unit 30 to be more ideally positioned than a USB port or lighter port may be.

The alarm unit 30 could notify an operator of the system status in various ways, including visual text, graphics or images illuminated on the alarm unit 30, or shown on an electronic display or screen. Additionally, words and messages can be audibly produced by the alarm unit audio output 38 to notify the operator. The alarm unit 30 could alternatively be an off-the-shelf Bluetooth-enabled or WiFi-enabled smart device running a specialized software application to monitor the wireless channel for the sensor unit's broadcast and could notify the operator through a built-in display screen and/or speaker. One example of this type of embodiment would be an application running on a tablet that is able to read a nearby sensor unit's wireless data broadcast. This type of embodiment seems particularly reasonable since the use of tablets within the cab of mixer trucks are already widely adopted for other purposes.

The system described could be advanced with more sensing technologies to avoid notifying the operator of intentional discharge by monitoring things like the motion or location of the entire mixer truck 60 (through GPS, accelerometers and gyroscopes, cameras, position of the gas pedal or other controls like a brake or transmission gear selection, etc.). Using these additional sources of situational information, the system could filter out instances when the truck 60 is stationary in places where discharge is expected to intentionally occur and only notify the operator of discharge rotation while the truck 60 is in transit.

In a preferred embodiment, the alarm unit 30 is agnostic to the specific sensor unit 10 which it wirelessly communicates with. In practice, this affordance allows the system components to be quickly swapped out without the need for pairing the devices or other means to synchronize or connect these units. The advantage of this is that when a sensor unit 10 is lost, damaged or has low batteries, it can be removed and quickly replaced by another sensor unit 10. Additionally, multiple sensor units could be placed on the same mixer drum 62 to create system redundancy. The advertisement protocol in Bluetooth Low Energy (BLE) allows broadcasts of small amounts of information within short data packets that nearby receivers listening to BLE devices can detect. Utilizing this well supported mode of BLE devices allows for hot-swapping of the sensor unit 10 and alarm unit 30 in a preferred embodiment.

### Exemplary Embodiment

In the preferred embodiment, the alarm unit 30 would remain in a stationary position inside the cab of the mixer truck 66, within the normal view and reach of the operator while driving. A mounted location of the alarm unit 30 would help to ensure that it remains near the operator while driving and is not easily moved or misplaced. This mounting location could be on the window, dashboard, center console or other location within the truck cab 66. The alarm unit 30 does not need to be permanently mounted but should not readily dislodge from its desired location. The alarm unit 30 should have access to electrical power from the mixer truck 60 so that it can remain powered on when the engine is running. A rechargeable battery 33 would be employed to help ensure that the alarm unit 30 remains functional for short periods of time if it may need to temporarily disconnect from external power.

In the preferred embodiment, alarm unit 30 has a sound producing output 38 such as a speaker or piezo-electric tone generator to produce an alerting sound sufficiently loud enough for an operator in the truck cab 66 to hear while the mixer truck's engine is running. The alarm unit 30 also has an indicator light 40 that changes colors based on the system status that would be sufficiently bright for an operator to see in daylight. There is a snooze feature input 36 that can be activated with an easily accessible button 37 on the alarm unit 30 to silence the device for a predetermined amount of time.

In the preferred embodiment, the sensor unit 10 would be directly mounted to the mixer drum 62 in the preferred location 55. It would be magnetically attached to the mixer drum 62 so that it can be quickly and easily be attached and removed without the use of tools and remain sufficiently attached for regular operation. It would utilize an inertial measurement unit that contains both an accelerometer and a gyroscope 14 and be configured to use the accelerometer as a tilt sensor 18 to wake from a power-saving mode when a tilt movement event is detected, then use the gyroscope 14 to measure the direction and speed of rotation of the mixer drum 62. A microcontroller 16 within the sensor unit 10 could use a simple filtering algorithm to determine if the speed and direction measured corresponds to the behavior of the mixer drum 62 in discharge rotation. If it does, the microcontroller 16 would use a wireless transmitter 12 to broadcast a signal using Bluetooth Low Energy (BLE) with an advertising packet containing data corresponding to the discharge rotation.

The alarm unit 30 would be continuously monitoring any nearby Bluetooth devices, actively searching for advertising packets from the sensor unit 10. Once an advertising packet is detected, the data is read and the alarm unit's microcontroller 34 which determines which audio and visual signals to produce to notify the operator of the system status. Besides the notification of discharge rotation, additional system status notifications could include but not limited to, the sensor unit's battery level, the snooze status, and/or the alarm unit's battery level.

The sensor unit's top housing 11 and bottom housing 19 would be sufficiently robust to withstand the environmental conditions experienced by the exterior of a mixer truck 60. The sensor housing should utilize waterproofing to protect the electronics from water ingress. The top housing 11 should also use electromagnetically permeable materials so that the wireless signal can easily be transmitted through the housing on the side of the sensor unit 10, generally facing away from the mixer drum 62 when installed.

The benefits of the disclosed preferred embodiment are primarily ease of use, installation and maintenance, sensing robustness, long-term system reliability, and effectiveness of grabbing the operator's attention quickly enough without interfering with the normal operation of the mixer truck 60 or mixer drum 62. The preferred embodiment disclosed is simple enough that it can be set up by any person within a few minutes without the use of any tools, equipment or special training and be retrofitted to a wide range of mixer trucks.

What is claimed is:

1. An apparatus for monitoring rotation of a mixer drum that can alert an operator when the mixer drum is rotating in discharge rotation, the apparatus comprising:
A means for detecting rotation of the mixer drum in the discharge rotational direction of within about 5 seconds or within about 180 degrees of rotation of the drum, after the drum begins to rotate in the said direction;
A means for producing at least one of an audible signal or a visual signal sufficiently perceivable by the operator, whereby the operator can be notified that discharge rotation.

2. The apparatus of claim 1, where the means for detecting rotation of the mixer drum in the discharge rotational direction comprises a gyroscope mechanically coupled to the mixer drum such that it moves synchronously with the rotation of the mixer drum.

3. The apparatus of claim 1, where the means for detecting rotation of the mixer drum in the discharge rotational direction further comprises:
A first microcontroller configured to communicate with the gyroscope and determine if the mixer drum is rotating in discharge rotation;
A wireless transmitter configured to broadcast data from the first microcontroller.

4. The apparatus of claim 3 further comprising a tilt sensor that is configured to wake the first microcontroller upon a predetermined motion event.

5. The apparatus of claim 3 wherein the first microcontroller, wireless transmitter and gyroscope are within a protective housing that magnetically mounts externally to the mixer drum.

6. The apparatus of claim 1, where the means for producing at least one of an audible signal or a visual signal sufficiently perceivable by the operator comprises:
A wireless receiver capable of receiving data from the first microcontroller via the wireless transmitter;
A means for detecting user input, such as a button that can be pressed by the operator;
A second microcontroller configured to read the data passed through the wireless receiver from the first microcontroller, and to read the user input to determine the system status;
An audio output configured to be controlled by the second microcontroller;
A light output configured to be controlled by the second microcontroller, whereby the second microcontroller can control the behavior of the audio output and light output based on the system status.

7. A system for alerting a driver of a mixer truck with a mixing drum when the mixing drum is rotating in discharge rotation, the system comprising:
A first device, mechanically coupled to the mixer drum, with a means for monitoring the mixer drum's rotational movement and a means for wirelessly broadcasting a signal containing data correlating to the mixer drum's rotational status;
A second device, remotely located from the first device, with a means to receive data wirelessly transmitted from the first device, and with a means of producing at least one of an audible or visual signal to capably notify the driver of discharge rotation of the mixer drum quickly enough after the start of said rotation, whereby the drive can take action to prevent an accidental spill.

8. The system of claim 7, where the means of monitoring the mixer drum's rotational movement by the first device, comprises:
A gyroscope oriented such that its axis of measurement is nearly parallel to the mixer drum's axis of rotation;
A first microcontroller configured to receive signals from the gyroscope to determine the rotational direction of the mixer drum.

9. The system of claim 8, further comprising a tilt sensor configured to wake the first microcontroller from a power-saving mode upon detecting a predetermined tilt motion event.

10. The system of claim 7, where the first device further comprises magnetic components configured to allow the device to sufficiently mount to the exterior of a mixer drum made from a ferric material.

11. The system of claim 7, where the means of wirelessly broadcasting a signal is a wireless transceiver coupled to the first processor and configured to produce a Bluetooth Low-Energy advertising data packet.

12. A method for alerting an operator of a mixing drum when discharge rotation has started, the method comprising:
Providing a means for monitoring a mixer drum's change in rotational direction;
Determining if said change in rotational direction corresponds to the start of discharge rotation of the mixer drum;
Producing at least one of an audible signal or a visual signal sufficiently perceivable by a human operator, within approximately 5 seconds or within approximately 180 degrees after the mixer drum begins rotating in discharge rotation, whereby the human operator can take action to stop drum rotation to prevent an accidental spill.

13. The method of claim 12, wherein providing a means for monitoring the mixer drum's change in rotation comprises a gyroscope mechanically coupled to the mixer drum.
